(19) United States
(12) Patent Application Publication
(10) Pub. No.: US 2026/0290632 A1
(43) Pub. Date: Sep. 24, 2026

(54) SPENT NUCLEAR FUEL DISPOSAL CONTAINER FOR RECOVERING DECAY HEAT BY APPLYING THERMOELECTRIC ELEMENT

(71) Applicant: KOREA RADIOACTIVE WASTE AGENCY, Gyeongsangbuk-do (KR)

(72) Inventors: Seung Hyun KIM, Daejeon (KR); Hyungoo KANG, Daejeon (KR); Sang Hwan LEE, Daejeon (KR); Sang Hyuk YUN, Daejeon (KR); Yun Jung CHOI, Daejeon (KR); Tae Chul MOON, Daejeon (KR)

(21) Appl. No.: 19/475,666

(22) PCT Filed: Feb. 5, 2024
(86) PCT No.: PCT/KR2024/001641

§ 371 Date: Oct. 15, 2025

(30) Foreign Application Priority Data
Apr. 19, 2023 (KR) 10-2023-0051094

(51) Int. Cl. G21C 3/40; G21F 1/08; G21F 5/008; G21F 5/10; G21F 5/12

(52) U.S. Cl. CPC G21C 3/40; G21F 1/08; G21F 5/008; G21F 5/10; G21F 5/12

(57) ABSTRACT

The present invention relates to a spent nuclear fuel disposal container for recovering decay heat by applying a thermoelectric element. The spent nuclear fuel disposal container for recovering decay heat by applying a thermoelectric element has a power generation module, including the thermoelectric element, installed inside a lid, and thus can generate electrical energy with high efficiency by using heat generated from spent nuclear fuel.

### CROSS REFERENCE TO RELATED APPLICATIONS

The present application is a U.S. National Phase of International Application No. PCT/KR2024/001641 entitled “SPENT NUCLEAR FUEL DISPOSAL CONTAINER FOR RECOVERING DECAY HEAT BY APPLYING THERMOELECTRIC ELEMENT”, and filed on Feb. 5, 2024. International Application No. PCT/KR2024/001641 claims priority to Republic of Korea Patent Application No. 10-2023-0051094 filed on Apr. 19, 2023. The entire contents of each of the above-listed applications are hereby incorporated by reference for all purposes.

### TECHNICAL FIELD

The present disclosure relates to a spent nuclear fuel disposal container for recovering decay heat by using a thermoelectric element, and more particularly, to a spent nuclear fuel disposal container for recovering decay heat by using a thermoelectric element, the disposal container being equipped with a power generation module including the thermoelectric element, and capable of generating electrical energy by utilizing heat generated from the spent nuclear fuel.

### BACKGROUND ART

Spent nuclear fuel refers to nuclear fuel used for nuclear power generation in a reactor such as a heavy water reactor (e.g., Canada deuterium uranium (CANDU)), and may be stored in a specially-designed storage container and stored in a storage location before its final disposal.

A storage method of spent nuclear fuel may be largely classified into a wet storage method and a dry storage method. In recent years, the dry storage method, which is advantageous in terms of capacity expansion and long-term management, has been widely used. The dry storage method of spent nuclear fuel has advantages such as superior safety, low operating cost, and increased storage capacity compared to those of the wet storage method.

When storing the spent nuclear fuel, a large amount of heat may be generated from the spent nuclear fuel. In general, heat generated from the spent nuclear fuel may be dissipated by natural convection or the like and released into an external atmosphere. However, a method to utilize heat generated from the spent nuclear fuel instead of releasing heat to the external atmosphere is also being sought.

For example, Korean Patent Publication No. 10-2022-0166538 discloses a dry storage device in which a thermoelectric unit surrounds an outer surface of a canister storing the spent nuclear fuel.

In detail, the dry storage device disclosed in Korean Patent Publication No. 10-2022-0166538 may utilize the thermoelectric unit including a thermoelectric element to generate electrical energy by using heat generated from the spent nuclear fuel, and utilize the generated electrical energy to autonomously supply power necessary for monitoring performance of the dry storage device.

Meanwhile, the thermoelectric element may generate a larger amount of electrical energy as a temperature difference between two types of metals included in the thermoelectric element increases. In the dry storage device disclosed in Korean Patent Publication No. 10-2022-0166538, the thermoelectric unit may surround the outer surface of the canister, which has a lower temperature than the inside of the canister. Accordingly, the temperature difference between the two types of metals included in the thermoelectric element may decrease when the thermoelectric unit is disposed inside the canister, thereby generating a smaller amount of electrical energy.

Therefore, it is necessary to seek a method to utilize heat generated from the spent nuclear fuel to generate a larger amount of electrical energy by using the thermoelectric element.

### DISCLOSURE

### Technical Problem

An object of the present disclosure is to provide a spent nuclear fuel disposal container for recovering decay heat by using a thermoelectric element, which may generate electrical energy in a highly efficient manner by utilizing heat generated from spent nuclear fuel.

Another object of the present disclosure is to provide a spent nuclear fuel disposal container for recovering decay heat by using a thermoelectric element, which may minimize deterioration of a thermoelectric element by neutrons emitted from spent nuclear fuel.

Technical aspects of the present disclosure are not limited to those mentioned above, and other aspects not mentioned here may be clearly understood by those skilled in the art from the following description.

### Technical Solution

In one general aspect, provided is a spent nuclear fuel disposal container for recovering decay heat by using a thermoelectric element, the disposal container including: a container including a lower surface, a side surface, and an open top to form a space inside, the space capable of accommodate spent nuclear fuel; a lid capable of sealing the space by covering the top of the container; and a power generation module installed inside the lid and generating electrical energy by utilizing heat generated from the spent nuclear fuel, wherein the power generation module includes a thermoelectric element including a negative (N)-type element and a positive (P)-type element.

The power generation module may include a neutron absorbing member disposed below the thermoelectric element to face one surface of the thermoelectric element and absorbing neutrons emitted from the spent nuclear fuel, and a heat dissipation plate disposed on top of the thermoelectric element to face the other surface of the thermoelectric element and cool the thermoelectric element by being in contact with the thermoelectric element.

The container may be formed in a cylindrical shape having a circular lower surface, and the thermoelectric element may have a circular cross-section parallel to the lower surface.

The side surface may have a first distance as a shortest distance between a virtual line segment and an outer peripheral surface of the side surface, the virtual line segment passing through a center of the lower surface and perpendicular to the lower surface, and a second distance as a shortest distance between the virtual line segment and an inner peripheral surface of the side surface, and a radius of the cross-section of the thermoelectric element, the cross-section being parallel to the lower surface, may have a length greater than or equal to the first distance and less than the second distance.

The neutron absorbing member entirely may face the one surface of the thermoelectric element, and the heat dissipation plate may entirely face the other surface of the thermoelectric element.

The neutron absorbing member may include boron, and the heat dissipation plate may include copper.

The lid may include cast iron.

Details of other embodiments are included in the description and drawings of the present disclosure.

### Advantageous Effects

According to the technical solution in the present disclosure described above, the spent nuclear fuel disposal container for recovering decay heat by using a thermoelectric element according to the present disclosure may be equipped with the power generation module including the thermoelectric element and installed inside the lid. Accordingly, the temperature of one of the two types of metals included in the thermoelectric element may effectively increase, and the temperature difference between the two types of metals included in the thermoelectric element may thus increase, thereby generating the electrical energy in the highly efficient manner.

In addition, the power generation module may include the neutron absorbing member installed below the thermoelectric element and absorbing the neutrons, thereby minimizing the deterioration of the thermoelectric element caused by the neutrons emitted from the spent nuclear fuel.

### DESCRIPTION OF DRAWINGS

FIG. 1 is a view showing a spent nuclear fuel disposal container for recovering decay heat by using a thermoelectric element according to an embodiment of the present disclosure.

FIG. 2 is a view showing a container.

FIG. 3 is a view showing a lid.

FIG. 4 is a view showing a power generation module.

FIG. 5 is a view showing a thermoelectric element.

FIG. 6 is a view showing the spent nuclear fuel disposal container for recovering decay heat by using a thermoelectric element in which a spent nuclear fuel is accommodated in a space of the container.

### Description of Reference Numerals

1: spent nuclear fuel disposal container for recovering decay heat by using a thermoelectric element
100: container
110: lower surface
120: side surface
130: space
200: lid
210: power generation module
212: thermoelectric element
214: neutron absorbing member
216: heat dissipation plate
300: spent nuclear fuel

### BEST MODE

Hereinafter, the embodiments of the disclosure are described in detail with reference to the accompanying drawings so that those skilled in the art to which the disclosure pertains may easily practice the disclosure. However, the present disclosure may be modified in various different forms, and is not limited to the embodiments provided herein. In addition, in the drawings, portions unrelated to the description are omitted to clearly describe the present disclosure, and similar portions are denoted by similar reference numerals throughout the specification.

Throughout the specification, when one part is referred to as being “connected to” another part, one part and another part may be “directly connected to” each other, or may be “electrically connected to” each other with a third part interposed therebetween.

Throughout the specification, when one member is referred to as being disposed “on” another member, one member and another member may be in contact with each other, or a third member may be interposed between one member and another member.

Throughout the specification, “including” one component is to be understood to imply the inclusion of another component rather than the exclusion of another component, unless explicitly described to the contrary. As used throughout the specification, a term of degree such as “about”, “substantially”, or the like is used to indicate the number of a stated meaning or its approximation when its manufacturing or material tolerance inherent therein is given. Such a term is used to prevent unscrupulous infringers from unfairly using the present disclosure in which exact or absolute figures are stated to facilitate the understanding of this application. As used throughout the specification, a term such as a “step of (doing)” or a “step of~” does not indicate a “step for~”.

Hereinafter, the embodiments of the present disclosure are described in detail with reference to the accompanying drawings and the descriptions provided below. However, the present disclosure is not limited to the embodiments described herein, and may also be embodied in another form. The same reference numerals denote the same components throughout the specification.

Hereinafter, the description describes a configuration of a spent nuclear fuel disposal container for recovering decay heat by using a thermoelectric element according to an embodiment of the present disclosure.

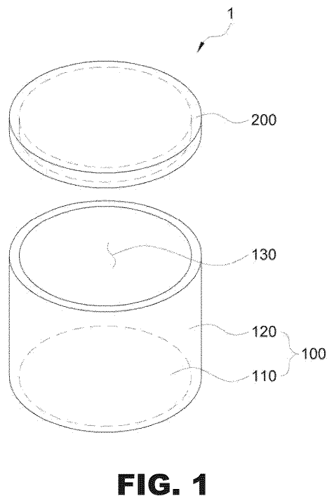

FIG. 1 is a view showing the spent nuclear fuel disposal container for recovering decay heat by using a thermoelectric element according to an embodiment of the present disclosure.

Referring to FIG. 1, a spent nuclear fuel disposal container 1 for recovering decay heat by using a thermoelectric element may include a container 100 and a lid 200.

First, the description describes the container 100.

As shown in FIG. 1, the container 100 may include a lower surface 110 and a side surface 120, and an open top to form a space 130 inside.

The lower surface 110 may be formed in various shapes, and may also be formed in a circular shape. When the lower surface 110 is formed in the circular shape, the container 100 may be formed in a cylindrical shape having the circular lower surface 110.

The side surface 120 may extend upwards from the lower surface 110, and in a case where the container 100 is formed in the cylindrical shape, the cross section parallel to the lower surface 110 may be annular.

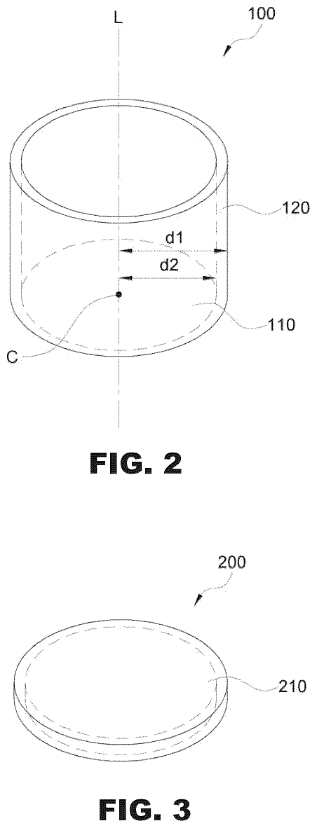

FIG. 2 is a view showing the container.

For example, as shown in FIG. 2, when the container 100 is formed in the cylindrical shape, the side surface 120 may have a first distance d1 as the shortest distance between a virtual line segment L and an outer peripheral surface of the side surface 120, the virtual line segment L passing through a center C of the lower surface 110 and perpendicular to the lower surface 110, and a second distance d2 as the shortest distance between the virtual line segment L and an inner peripheral surface of the side surface 120.

Meanwhile, the space 130 formed in the container 100 may accommodate spent nuclear fuel 300.

Next, the description describes the lid 200.

As shown in FIG. 1, the lid 200 may seal the space 130 by covering the open top of the container 100, and may include a material such as cast iron.

In addition, the lid 200 may be formed in a shape corresponding to a shape of the container 100. For example, when the container 100 is formed in the cylindrical shape, the lid 200 may have a circular cross-section parallel to the lower surface 110 of the container 100.

FIG. 3 is a view showing the lid.

Meanwhile, as shown in FIG. 3, a power generation module 210 may be installed inside the lid 200. The power generation module 210 may include a thermoelectric element 212 to generate electrical energy by utilizing heat generated from the spent nuclear fuel accommodated in the container 100.

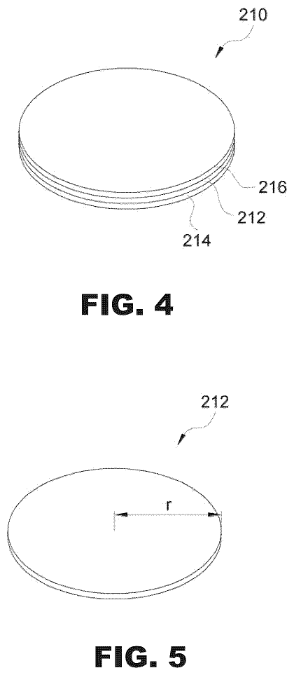

FIG. 4 is a view showing the power generation module.

In detail, referring to FIG. 4, the power generation module 210 may include the thermoelectric element 212, a neutron absorbing member 214, and a heat dissipation plate 216.

The thermoelectric element 212 may utilize the Seebeck effect to generate electrical energy, may be a conventional thermoelectric element including a negative (N)-type element and a positive (P)-type element, and may be installed inside the lid 200 by having one surface facing the lower surface 110 of the container 100 and the other surface facing an upper surface of the lid 200.

FIG. 5 is a view showing the thermoelectric element.

Meanwhile, when the container 100 is formed in the cylindrical shape, as shown in FIG. 5, the thermoelectric element 212 may be formed in a circular cross-section parallel to the lower surface 110.

In addition, as described above, when the shortest distance between the virtual line segment L and the outer peripheral surface of the side surface 120 is the first distance d1, and the shortest distance between the virtual line segment L and the inner peripheral surface of the side surface 120 is the second distance d2, a radius r of the cross-section of the thermoelectric element 212, the cross-section being parallel to the lower surface 110, may have a length greater than or equal to the first distance d1 and less than the second distance d2.

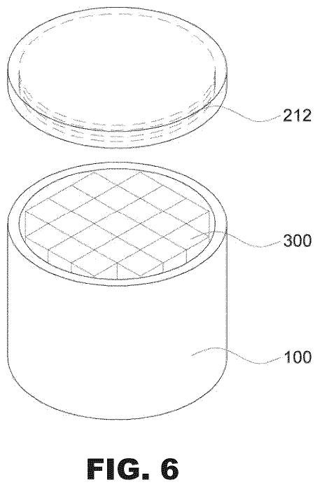

FIG. 6 is a view showing the spent nuclear fuel disposal container for recovering decay heat by using a thermoelectric element in which the spent nuclear fuel is accommodated in the space of the container.

That is, as shown in FIG. 6, when the lid 200 covers the container 100 accommodating the spent nuclear fuel 300, the thermoelectric element 212 may be formed in such a way that one surface of the thermoelectric element 212, which faces the space 130, has the largest possible area to allow heat to be transferred from the space 130 to the thermoelectric element 212 as effectively as possible.

The neutron absorbing member 214 may be disposed below the thermoelectric element 212 to face one surface of the thermoelectric element 212, and may be made of a conventional member capable of absorbing neutrons to absorb the neutrons emitted from spent nuclear fuel 300 to the thermoelectric element 212. The neutron absorbing member 214 may include boron or the like.

In addition, as shown in FIG. 4, the neutron absorbing member 214 may entirely face one surface of the thermoelectric element 212 to effectively absorb the neutrons emitted to the thermoelectric element 212 from the spent nuclear fuel 300 accommodated in the container 100 as effectively as possible.

The heat dissipation plate 216 may be disposed on top of the thermoelectric element 212 to face the other surface of the thermoelectric element 212, and may be made of a conventional heat dissipation member capable of contacting a predetermined object to cool the predetermined object.

The heat dissipation plate 216 may cool the thermoelectric element 212 by being in contact with the thermoelectric element 212, and cool the other surface of the thermoelectric element 212 by including, for example, cooling fins including copper.

In addition, as shown in FIG. 4, the heat dissipation plate 216 may entirely face the other surface of the thermoelectric element 212 to cool the other surface of the thermoelectric element 212 as effectively as possible.

In this way, the other surface of the thermoelectric element 212 may be cooled by the heat dissipation plate 216 and one surface of the thermoelectric element 212 may be effectively heated by heat generated from the spent nuclear fuel 300. Accordingly, a temperature difference between one surface and the other surface of the thermoelectric element 212 may increase, thus enabling the thermoelectric element 212 to generate the electrical energy in a highly efficient manner.

Hereinafter, the description describes the operation and effect of the spent nuclear fuel disposal container for recovering decay heat by using a thermoelectric element of the present disclosure.

First, the container 100 having the space 130 formed inside may accommodate the spent nuclear fuel 300.

The container 100 may include the lower surface 110 and the side surface 120 and may be formed in the cylindrical shape. Next, the lid 200 may cover the open top of the container 100 to seal the space 130 where the spent nuclear fuel 130 is accommodated. Here, the power generation module 210 including the thermoelectric element 212 may be installed inside the lid 200 to generate the electrical energy by utilizing heat generated from the spent nuclear fuel 130.

Here, the power generation module 210 may maximize the temperature difference between one surface of the thermoelectric element 212, which receives heat from the spent nuclear fuel 300, and the other surface, which dissipates heat.

In detail, the thermoelectric element 212 may be formed in such a way that one surface of the thermoelectric element 212, which faces the space 130 accommodating the spent nuclear fuel 300, has the largest possible area, and the heat dissipation plate 216 disposed on top of the thermoelectric element 212 to cool the thermoelectric element 212 may entirely face the other surface of the thermoelectric element 212.

Meanwhile, the power generation module 210 may include the neutron absorbing member 214 disposed below the thermoelectric element 212 to face one surface of the thermoelectric element 212 in order to prevent deterioration of the thermoelectric element 212 caused by the neutrons emitted from the spent nuclear fuel 300.

In this way, the spent nuclear fuel disposal container for recovering decay heat by using a thermoelectric element according to the present disclosure may equipped with the power generation module including the thermoelectric element and installed inside the lid. Accordingly, a temperature of one of the two types of metals included in the thermoelectric element may effectively increase, and the temperature difference between the two types of metals included in the thermoelectric element may thus increase, thereby generating the electrical energy in the highly efficient manner.

In addition, the power generation module may include the neutron absorbing member installed below the thermoelectric element and absorbing the neutrons, thereby minimizing the deterioration of the thermoelectric element caused by the neutrons emitted from the spent nuclear fuel.

The above-described embodiments are illustratively provided, and it is apparent to those skilled in the art to which the present disclosure pertains that the present disclosure may be embodied in another specific form without any change in the technical idea or essential feature of the present disclosure. Therefore, it should be understood that the embodiments described above are illustrative rather than restrictive in all aspects. For example, the components each described as a single type may also be implemented in a distributed manner, and similarly, the components described as being distributed from each other may also be implemented in a combined manner.

It should be understood that the scope of the present disclosure is defined by the claims disclosed below rather than the detailed description provided above, and includes all alternations and modifications derived from the claims and their equivalents.

1. A spent nuclear fuel disposal container for recovering decay heat by using a thermoelectric element, the disposal container comprising:
a container including a lower surface, a side surface, and an open top to form a space inside, the space capable of accommodate spent nuclear fuel;
a lid capable of sealing the space by covering the top of the container; and
a power generation module installed inside the lid and generating electrical energy by utilizing heat generated from the spent nuclear fuel,
wherein the power generation module includes a thermoelectric element including a negative (N)-type element and a positive (P)-type element.

2. The disposal container of claim 1, wherein the power generation module includes
a neutron absorbing member disposed below the thermoelectric element to face one surface of the thermoelectric element and absorbing neutrons emitted from the spent nuclear fuel, and
a heat dissipation plate disposed on top of the thermoelectric element to face the other surface of the thermoelectric element and cool the thermoelectric element by being in contact with the thermoelectric element.

3. The disposal container of claim 2, wherein:
the container is formed in a cylindrical shape having a circular lower surface, and
the thermoelectric element has a circular cross-section parallel to the lower surface.

4. The disposal container of claim 3, wherein:
the side surface has a first distance as a shortest distance between a virtual line segment and an outer peripheral surface of the side surface, the virtual line segment passing through a center of the lower surface and perpendicular to the lower surface, and a second distance as a shortest distance between the virtual line segment and an inner peripheral surface of the side surface, and
a radius of the cross-section of the thermoelectric element, the cross-section being parallel to the lower surface, has a length greater than or equal to the first distance and less than the second distance.

5. The disposal container of claim 4, wherein:
the neutron absorbing member entirely faces the one surface of the thermoelectric element, and
the heat dissipation plate entirely faces the other surface of the thermoelectric element.

6. The disposal container of claim 5, wherein:
the neutron absorbing member includes boron, and
the heat dissipation plate includes copper.

7. The disposal container of claim 6, wherein the lid includes cast iron.
